(19) United States
(12) Patent Application Publication
(10) Pub. No.: US 2016/0168898 A1
(43) Pub. Date: Jun. 16, 2016

(54) DEVICE FOR OPENING AND CLOSING VEHICLE DOOR

(71) Applicant: AISIN SEIKI KABUSHIKI KAISHA, Kariya-shi (JP)

(72) Inventors: Sadayuki MAKINO, Nagoya-shi (JP); Kenta MORI, Kariya-shi (JP); Eisuke UMEMURA, Kasugai-shi (JP)

(73) Assignee: AISIN SEIKI KABUSHIKI KAISHA, Kariya-shi (JP)

(21) Appl. No.: 14/909,623

(22) PCT Filed: Mar. 7, 2014
(86) PCT No.: PCT/JP2014/055937

§ 371 Date: Feb. 2, 2016

(30) Foreign Application Priority Data
Aug. 22, 2013 (JP) 2013-172232

(51) Int. Cl. E05F 15/657; B60J 5/04; E05F 15/662

(52) U.S. Cl. CPC E05F 15/657; E05F 15/662; B60J 5/047; E05Y 2900/531

(57) ABSTRACT

A door opening and closing apparatus for a vehicle includes a drive member adapted to open and close a vehicle door opening and closing a door opening formed at a vehicle body. The drive member includes a flat motor including a rotating shaft, an output shaft including an axis line that is parallel with an axis line of the rotating shaft, a first gear and a second gear which are respectively connected to the rotating shaft and the output shaft to be integrally rotatable, the first gear and the second gear meshing with each other to decelerate rotation of the rotating shaft and then transmit the rotation to the output shaft, and an output member fixedly attached to the output shaft to rotate integrally with the output shaft and being adapted to be connected to the vehicle door.

### TECHNICAL FIELD

This invention relates to a door opening and closing apparatus for a vehicle.

### BACKGROUND ART

Conventionally, various door opening and closing apparatuses for a vehicle have been suggested. For example, a door opening and closing apparatus for a vehicle described in Patent document 1 moves, with the use of a driving force of a drive member or a manual operation force, a slide door linked to the drive member in a front and rear direction of a vehicle to open and close a door opening of the vehicle. The drive member includes a motor, a worm fixedly attached to a rotary shaft of the motor to rotate integrally therewith, a worm wheel meshing with the worm, an output shaft supporting the worm wheel and an output member fixedly attached to the output shaft to rotate integrally therewith. Power transmission between the worm wheel and the output shaft can be connected and disconnected by an electromagnetic clutch.

### DOCUMENT OF PRIOR ART

### Patent Document

Patent document 1: JP2003-74255A

### SUMMARY OF INVENTION

### Problem to be Solved by Invention

At the door opening and closing apparatus for the vehicle of Patent document 1, however, transmission efficiency from the worm wheel to the worm (which will be hereinafter referred to as “a reverse efficiency”) is lower than transmission efficiency from the worm to the worm wheel (which will be hereinafter referred to as “a positive efficiency”). Therefore, it is practically difficult to manually operate the slide door without providing a clutch including, for example, an electromagnetic clutch. In addition, the worm and the worm wheel function as a speed reducer, however, in order to enable the manual operation of the slide door, a position at which the clutch is arranged is practically limited to between the speed reducer and the output member due to the above-described problem of the reverse efficiency.

The purpose of this invention is to provide a door opening and closing apparatus for a vehicle, which allows a vehicle door to be manually operated even in a case where a clutch is not provided or which may enhance a degree of freedom in arranging the clutch in a case where the clutch is provided.

### Means for Solving Problem

A door opening and closing apparatus for a vehicle, which solves the above-mentioned problem includes a drive member adapted to open and close a vehicle door opening and closing a door opening formed at a vehicle body, the drive member includes a flat motor including a rotating shaft, an output shaft including an axis line that is parallel with an axis line of the rotating shaft, a first gear and a second gear which are connected respectively to the rotating shaft and the output shaft to be integrally rotatable, the first gear and the second gear meshing with each other to decelerate rotation of the rotating shaft and then transmit the rotation to the output shaft, and an output member fixedly attached to the output shaft to rotate integrally with the output shaft and being adapted to be linked to the vehicle door.

### BRIEF DESCRIPTION OF DRAWINGS

FIG. 1 is a longitudinal cross-sectional view illustrating a drive unit of a door opening and closing apparatus for a vehicle related to an embodiment of this invention.

FIG. 2 is a plan view illustrating the drive unit of FIG. 1.

FIG. 3 is a side view illustrating a vehicle provided with the drive unit of FIG. 1.

### MODE FOR CARRYING OUT THE INVENTION

An embodiment of a door opening and closing apparatus for a vehicle will be described hereunder. A front and rear direction of a vehicle will be hereinafter referred to simply as “front and rear direction”.

As illustrated in FIG. 3, a vehicle body 10 is provided with an upper rail 11 and a lower rail 12 in such a manner that the upper rail 11 and the lower rail 12 extend along an upper edge and a lower edge, respectively, of a door opening 10a formed at a side portion of the vehicle body 10. The vehicle body includes a quarter panel 10b positioned rearward relative to the door opening 10a, and a center rail 13 extending in the front and rear direction is provided at the quarter panel 10b. A slide door 20 serving as a vehicle door is supported to be movable in the front and rear direction by the upper rail 11, the lower rail 12 and the center rail 13 via guide roller units 14. The slide door 20 opens and closes the door opening 10a in association with a movement in the front and rear direction. A cable guide 15 is provided at the quarter panel 10b and the cable guide 15 extends along a lower edge of the center rail 13 over a substantially entire length of the center rail 13.

A drive member (or a drive unit) 21 is fixed to an inside of a lower portion of the slide door 20. The drive unit 21 includes a flat motor 22 formed by a permanent magnet motor and a drum 23 driven and rotated by the flat motor 22. “The flat motor” corresponds to a motor where a diameter (the maximum diameter) of an outer shape of the motor is set to be greater than a length of the outer shape of the motor in an axial direction of a rotary shaft. In addition, the drum 23 is an output member linked to the vehicle door. A first cable 24 and a second cable 25 are wound on the drum 23. Each of the first and second cables 24 and 25 is wound on the drum 23 in a state where a first end of each of the first and second cables 24 and 25 is connected to the drum 23. The first and second cables 24 and 25 are selectively wound up and wound out relative to the drum 23 in association with the driving of the drive member 21.

In addition, each of the first and second cables 24 and 25 is led to the vehicle body 10 from the slide door 20 via an intermediate pulley 26, and a guide pulley 27 linked to the guide roller unit 14 moving on the center rail 13, and then each of the first and second cables 24 and 25 is extended along the cable guide 15 in the front and rear direction. The first cable 24 is guided by the cable guide 15 and is arranged at a front portion of the vehicle, and is connected to the vehicle body 10 in the vicinity of a front end of the cable guide 15 via a tensioner 28 connected to a second end of the first cable 24. In addition, the second cable 25 is guided by the cable guide 15 and is arranged at a rear portion of the vehicle, and is connected to the vehicle body 10 in the vicinity of a rear end of the cable guide 15 via a tensioner 29 connected to a second end of the second cable 25.

For example, in a case where the second cable 25 is wound up by the drive member 21 while the first cable 24 is being wound out by the drive member 21, the slide door 20 moves in the rear direction of the vehicle to open the door opening 10a. On the other hand, in a case where the second cable 25 is wound out by the drive member 21 while the first cable 24 is being wound up by the drive member 21, the slide door 20 moves in the front direction of the vehicle to close the door opening 10a.

Next, a structure of the drive member 21 will be explained.

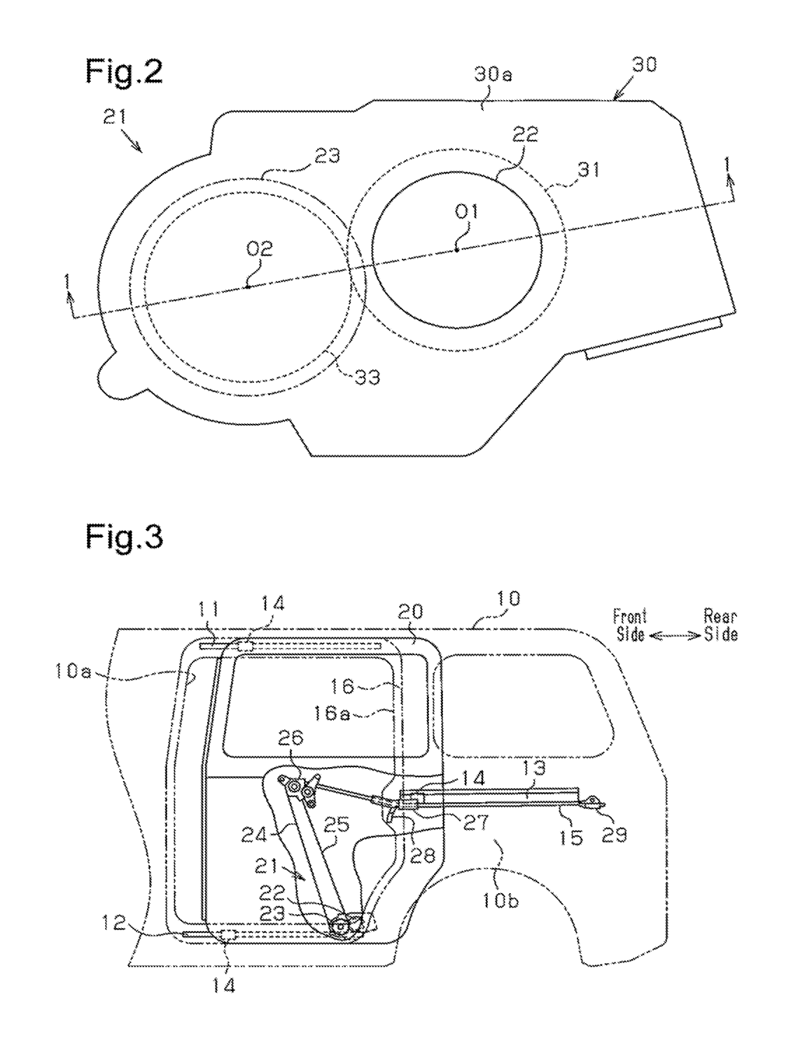

As illustrated in FIG. 2, the drive member 21 includes a case 30 formed in a box shape, and accommodating or supporting various components. An outer wall surface 30a of the case 30 spreads in a substantially planar shape, and the flat motor 22 and the drum 23 are provided at the outer wall surface 30a.

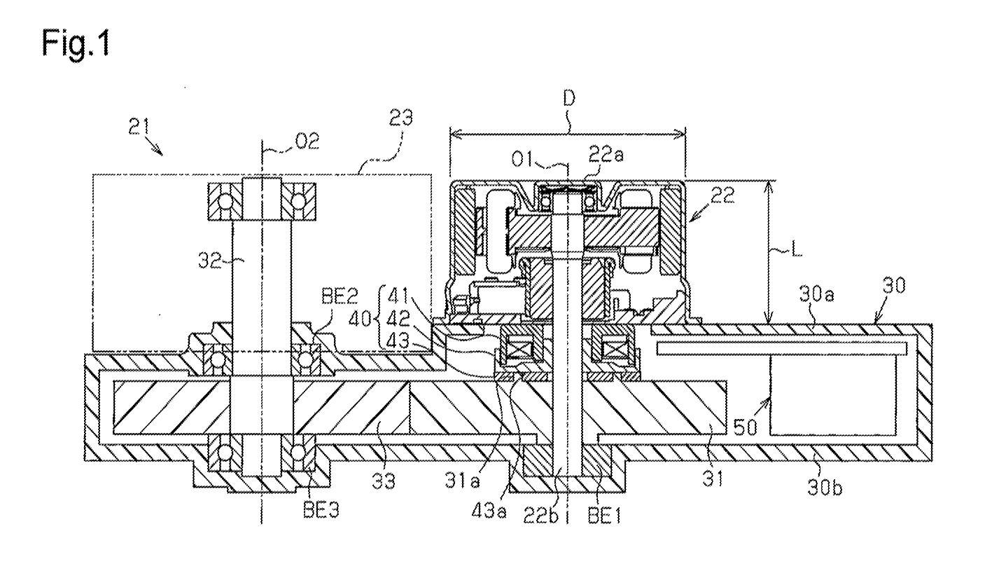

That is, as illustrated in FIG. 1, a motor case 22a formed in a substantially circular cylinder with a lid and a bottom and forming an outer shape of the flat motor 22 is provided at the outer wall surface 30a of the case 30 which corresponds to an upper side of the case 30 in FIG. 1. The motor case 22a includes a length L in a direction of an axis line O1 and a diameter D that is greater than the length L. A rotating shaft 22b of the flat motor 22 which includes a substantially circular columnar shape penetrates the outer wall surface 30a along the axis line O1 in a thickness direction. A distal end portion of the rotating shaft 22b entered in the case 30 is supported by a bearing BE1 fitted and attached to an outer wall surface 30b. The outer surface 30b is substantially parallel with the outer wall surface 30a and is at a side opposite to the outer wall surface 30a.

A first gear 31 formed by, for example, a spur gear, is rotatably supported by the rotating shaft 22b, at a position next to the bearing BE1 within the case 30. The first gear 31 includes plural engagement protrusions 31a each extending towards the flat motor 22 to be substantially parallel with the axial line O1. In addition, an electromagnetic clutch 40 is provided around the rotating shaft 22b to be positioned between the flat motor 22 and the first gear 31 inside the case 30. The electromagnetic clutch 40 includes an electromagnetic coil body 41, a rotor 42 and an armature 43.

The electromagnetic coil body 41 is formed in a substantially annular shape including a center line matching the axis line O1, and is fixedly attached to the motor case 22a in a state where the electromagnetic coil body 41 penetrates the outer wall surface 30a in the thickness direction. The electromagnetic coil body 41 is arranged around the rotating shaft 22b to be away from the rotating shaft 22b.

The rotor 42 is made of a magnetic material and is formed in a substantially annular shape including a center line matching the axis line O1, and is fixedly attached to the rotating shaft 22b in a state where the rotor 42 is sandwiched between the electromagnetic coil body 41 and the armature 43 so as to rotate integrally with the rotating shaft 22b. At an opposing surface of the rotor 42, the opposing surface being in contact with the armature 43, a friction plate (not shown) is provided in a buried condition. The rotor 42 is fitted, with a play, to the electromagnetic coil body 41 to be rotatable relative to the electromagnetic coil body 41 in such a manner that a position of the rotor 42 in a direction of the axis line O1 partly overlaps with the electromagnetic coil body 41.

The armature 43 is made of a magnetic material and is formed in a substantially annular shape including a center line matching the axis line O1, and is sandwiched between the rotor 42 and the first gear 31. The armature 43 is arranged around the rotating shaft 22b to be away from the rotating shaft 22b. In addition, the armature 43 includes plural engagement holes 43a corresponding to the plural engagement protrusions 31a of the first gear 31, respectively, and the engagement holes 43a are formed to penetrate the armature 43 in a direction which is substantially parallel with the axis line O1. As the engagement protrusions 31a fit in the respective engagement holes 43a, the armature 43 is connected to the first gear 31 to rotate integrally with the first gear 31. An outer diameter of the armature 43 is equivalent to an outer diameter of the rotor 42. A friction plate (not shown) is provided in a buried condition also at an opposing surface of the armature 43, the opposing surface being in contact with the rotor 42.

An output shaft 32 formed in a substantially circular columnar shape and including an axis line O2 which is parallel with the axis line O1 penetrates the outer wall surface 30a in the thickness direction thereof. Inside the case 30, the output shaft 32 is supported by bearings BE2 and BE3 which are fitted and attached to the outer wall surfaces 30a and 30b, respectively. A second gear 33 formed by, for example, a spur gear, is fixed to the output shaft 32 between the both bearings BE2 and BE3 within the case 30 to rotate integrally with the output shaft 32. The second gear 33 and the first gear 31 mesh with each other, and transmit to each other rotations of which directions are opposite to each other. At this time, the second gear 33 rotates at a rotational speed which is smaller than a rotational speed of the first gear 31 in accordance with a rotational speed transmission ratio based on the number of teeth of the first gear 31 and the number of teeth of the second gear 33.

The drum 23 is fixed to a portion of the output shaft 32, the portion which protrudes outside the case 30 from the outer wall surface 30a, so as to integrally rotate. In other words, the flat motor 22 and the drum 23 are arranged at an outer side of the case 30 to be arranged at the same side as each other in the direction of the axis lines O1 and O2 of the rotating shaft 22b and the output shaft 32, that is, at the same side as each other relative to the first gear 31 and the second gear 33.

An electronic control unit (which will be hereinafter referred to as “ECU”) 50 is accommodated within the case 30 to be at a side opposite to the second gear 33 relative to the first gear 31. The ECU 50 is electrically connected to an external device (an external power source, for example), and is electrically connected to the flat motor 22 and the electromagnetic clutch 40. The ECU 50 controls electrification and non-electrification of the flat motor 22, thereby controlling the driving thereof. Alternatively, the ECU 50 controls electrification and non-electrification of the electromagnetic coil body 41, thereby controlling the driving of the electromagnetic clutch 40.

Next, an operation of this embodiment will be explained.

For example, in a case where the electromagnetic coil body 41 is brought into an electrified state by the ECU 50, due to a magnetic field formed by the coil body 41, the armature 43 is attracted by the rotor 42, and thus the armature 43 and the rotor 42 frictionally engage with each other (a connected state). In the connected state of the electromagnetic clutch 40, in a case where the flat motor 22 is driven by the ECU 50, the rotor 42 rotates integrally with the rotational shaft 22b. Then, the rotation of the rotor 42 is transmitted to the armature 43 frictionally engaged with the rotor 42. Accordingly, the first gear 31 rotates integrally with the armature 43.

The rotation of the first gear 31 is decelerated and then transmitted to the second gear 33 meshed with the first gear 31. Accordingly, the output shaft 32 and the drum 23 rotate integrally with the second gear 33. The first gear 31 and the second gear 33, which are involved in the transmission of the rotation between the rotating shaft 22b and the output shaft 32, configure a so-called speed reduction mechanism including a group of gears with parallel shafts, and therefore the positive efficiency between the gears 31 and 33 is extremely high. Because the positive efficiency between the gears 31 and 33 is high, the flat motor 22 of which an output is small may be used, accordingly. As described above, the slide door 20 is operated to open and close in association with the rotation of the drum 23.

On the other hand, in a case where the electromagnetic coil body 41 is brought into a nonelectrified state by the ECU 50 and thus the electromagnetic clutch 40 is brought into a disconnected state, the frictional engagement of the rotor 42 and the armature 43 with each other is released. Therefore, even in a case where the flat motor 22 is driven by the ECU 50 and thus the rotor 42 rotates integrally with the rotation shaft 22b, the rotation of the rotor 42 is not transmitted to the armature 43. That is, the first gear 31, the second gear 33, the output shaft 32 and the drum 23 remain stopped together with the armature 43.

In a case where the drum 23 is rotated by, for example, an external force, the output shaft 32 and the second gear 33 rotate integrally with the drum 23. The rotation of the second gear 33 is transmitted to the first gear 31 meshed with the second gear 33. Thus, the armature 43 rotates integrally with the first gear 31. However, because the frictional engagement of the armature 43 and the rotor 42 with each other is released, the rotation of the armature 43 is not transmitted to the rotor 42. Consequently, the rotating shaft 22b of the flat motor 22 does not rotate even in a case where the drum 23 is rotated by the manual opening and closing operation of the slide door 20, and thus the operation force required for such opening and closing operation is reduced.

As described in detail above, according to this embodiment, the advantages described below may be obtained.

(1) In this embodiment, the first gear 31 and the second gear 33 which are involved in the transmission of the rotation between the rotating shaft 22b and the output shaft 32 configure the so-called speed reduction mechanism formed by the gear group with parallel shafts, and thus decrease in the reverse efficiency which occurs in a case where the worm and the worm wheel are used does not occur. Consequently, the slide door 20 can be operated manually even in a case where the clutch is not provided. In addition, in a case where the clutch is provided, the clutch may be arranged between the drum 23 and the second gear 33 or between the rotating shaft 22b and the first gear 31, for example. That is, a degree of freedom in arranging the clutch may be enhanced. Further, in a case where the speed reduction mechanism is modified to include the group of gears with parallel shafts instead of the worm and worm wheel, a direction of the rotating shaft 22b is also changed by substantially 90 degrees as a result. However, because the flat motor 22 is used as the motor, a size of the door opening and closing apparatus for the vehicle in the direction of the output shaft can be prevented from increasing even in a case where the gear groups with the parallel shafts are employed.

(2) In this embodiment, by disconnecting the power transmission between the rotating shaft 22b and the first gear 31 with the use of the electromagnetic clutch 40 in a case where the slide door 20 is opened and closed manually, the rotating shaft 22b is prevented from rotating in association with the opening and closing of the slide door 20. Accordingly, an influence of a cogging force caused by the rotation of the rotating shaft 22b is overcome, and thus the operation force required for manually opening and closing the slide door 20 can be reduced. In addition, in a state where the electromagnetic clutch 40 allows the power transmission between the rotating shaft 22b and the first gear 31, the electromagnetic clutch 40 transmits the rotation which has not been decelerated and includes a relatively low torque. Consequently, a clutch including a smaller holding torque and having a small size, a light weight and low costs may be used as the electromagnetic clutch 40.

(3) In this embodiment, in a state where the electromagnetic clutch 40 allows the power transmission between the rotating shaft 22b and the first gear 31, the electromagnetic clutch 40 transmits the rotation which has not been decelerated and includes the relatively low torque. Consequently, the electromagnetic clutch 40 can achieve electric power saving. In addition, the electromagnetic clutch 40 itself can become lower in costs.

(4) In this embodiment, the flat motor 22 and the drum 23 are arranged at the same side as each other in the direction of the axis lines O1 and O2 of the rotating shaft 22b and the output shaft 32 relative to the first gear 31 and the second gear 33. Consequently, compared to a case where, for example, the flat motor 22 and the drum 23 are arranged at opposite sides to each other relative to the first gear 31 and the second gear 33 in the direction of the axis lines O1 and O2 of the rotating shaft 22b and the output shaft 32, the entire drive member 21 can be downsized more in the direction of the axis lines O1 and O2. That is, a space portion formed at a position that matches the arrangement position of the flat motor 22 in the direction of the axis lines O1 and O2 of the rotating shaft 22b and the output shaft 32 can be utilized, and the drum 23 can be arranged thereat.

(5) In this embodiment, by not using the worm gear to transmit the rotation between the rotating shaft 22b and the output shaft 32, the reverse efficiency between the shafts 22b and 32 can be enhanced, and the slide door 20 can be operated to open and close with a smaller operation force.

(6) In this embodiment, by providing the flat motor 22, the drive member 21 can be thin and ease of mounting the drive member 21 to the inside of the slide door 20 can be enhanced, even in a case where the rotation is transmitted with the group of gears with parallel shafts. In addition, necessity to increase a thickness of the slide door 20 for mounting the drive member 21 to the inside of the slide door 20 is reduced, and accordingly a larger space portion inside a vehicle cabin can be ensured.

(7) In this embodiment, by disconnecting the power transmission between the rotating shaft 22b and the first gear 31 with the use of the electromagnetic clutch 40 in a case where the slide door 20 is manually opened and closed at a high speed, the rotating shaft 22b does not rotate in association with the opening and closing of the slide door 20. Consequently, back electromotive force is prevented from occurring at the flat motor 22, and an influence on the ECU 50 is eliminated.

The aforementioned embodiment may be changed or modified as follows.

In the aforementioned embodiment, the first and second gears 31 and 33 may be helical gears.

In the aforementioned embodiment, between the first and second gears 31 and 33, a third gear may be provided which relays the power transmission between the first and second gears 31 and 33. In addition, the single gear may be provided as the third gear or plural gears may be provided as the third gears. That is, “the first gear 31 and the second gear 33 mesh with each other” includes not only that the first and second gears 31 and 33 mesh directly with each other but also that the first and second gears 31 and 33 mesh with each other indirectly via the third gear disposed therebetween.

In the aforementioned embodiment, the motor case 22a of the flat motor 22 may be formed in a cylindrical shape of a flattened circle including a short diameter and a long diameter, such as an oval shape, an egg shape or an elliptic shape. In this case, the motor case 22a may be set in such a manner that the long diameter is greater than the length in the axial direction.

In the aforementioned embodiment, the friction plate may be provided in the buried condition at either the rotor 42 or the armature 43. In addition, the friction plate is not necessarily required to cause the rotor 42 and the armature 43 to frictionally engage with each other.

In the aforementioned embodiment, the flat motor 22 and the drum 23 may be arranged at the sides that are opposite to each other in the direction of the axis lines O1 and O2 of the respective rotating shaft 22b and the output shaft 32 relative to the first gear 31 and the second gear 33.

A positional relationship of, for example, the rotor 42 of the electromagnetic clutch 40 and the armature 43 of the electromagnetic clutch 40 with each other in the aforementioned embodiment may be inverted. A positional relationship among the members constituting the electromagnetic clutch 40 may be of any kinds.

In the aforementioned embodiment, a clutch may be provided between the second gear 33 and the drum 23 so that the power transmission therebetween is established and interrupted.

In the aforementioned embodiment, a mechanical clutch may be used instead of the electromagnetic clutch 40.

In the aforementioned embodiment, the electromagnetic clutch 40 may be omitted. In this case, the rotating shaft 22b of the flat motor 22 rotates when the slide door 20 is opened and closed manually. However, the rotating shaft 22b rotates easily because the reverse efficiency between the first gear 31 and the second gear 33 is high, and accordingly the operation force required thereto can be reduced.

In the aforementioned embodiment, the drive member 21 may be configured to be mounted to the vehicle body 10.

This invention may be applied to a swing door and/or a back door, for example. In those cases, a pulley of a belt, an arm and so forth may be used appropriately as the output member. In addition, no matter which output member is used, it is more ideal that the flat motor and the output member are arranged at the same side as each other with respect to the first gear 31 and the second gear 33 in the direction of the axis lines of the rotating shaft and the output shaft.

1: A door opening and closing apparatus for a vehicle, comprising:
a drive member adapted to open and close a vehicle door opening and closing a door opening formed at a vehicle body, the drive member including:
a flat motor including a rotating shaft;
an output shaft including an axis line that is parallel with an axis line of the rotating shaft;
a first gear and a second gear which are respectively connected to the rotating shaft and the output shaft to be integrally rotatable, the first gear and the second gear meshing with each other to decelerate rotation of the rotating shaft and then transmit the rotation to the output shaft; and
an output member fixedly attached to the output shaft to rotate integrally with the output shaft and being adapted to be linked to the vehicle door
wherein the drive member includes a clutch connecting and disconnecting power transmission between the rotating shaft and the first gear.

2. (canceled)

3: The door opening and closing apparatus for the vehicle according to claim 1, wherein the clutch corresponds to an electromagnetic clutch.

4: The door opening and closing apparatus for the vehicle according to claim 1, wherein the flat motor and the output member are arranged at a same side as each other in a direction of axis lines of the rotating shaft and the output shaft relative to the first gear and the second gear.

5: The door opening and closing apparatus for the vehicle according to claim 1, wherein an outer shape of the flat motor includes a diameter which is greater than a length in the direction of the axis line of the rotating shaft.
